(19) United States
(12) Patent Application Publication
(10) Pub. No.: US 2025/0279468 A1
(43) Pub. Date: Sep. 4, 2025

(54) FREE-STANDING SULFIDE SOLID-STATE ELECTROLYTE MEMBRANES

(71) Applicant: UT-Battelle, LLC, Oak Ridge, TN (US)

(72) Inventors: Guang Yang, Knoxville, TN (US); Anna Mills, Oak Ridge, TN (US)

(21) Appl. No.: 19/066,900

(22) Filed: Feb. 28, 2025

Related U.S. Application Data
(60) Provisional application No. 63/559,425, filed on Feb. 29, 2024.

(51) Int. Cl. H01M 10/056

(52) U.S. Cl. CPC H01M 10/056; H01M 2300/0091

(57) ABSTRACT

A solid-state electrolyte is provided. The solid-state electrolyte includes a ceramic and a polymer binder. The ceramic includes a sulfide-containing electrolyte, and the polymer binder has a molecular weight of from 50 to 2000 kg/mol. A solid-state battery cell is also provided. The solid-state battery cell includes a casing and a cathode and an anode disposed within the casing. The solid-state battery cell further includes a current collector and a solid-state electrolyte membrane separating the cathode and the anode. The solid-state electrolyte includes a ceramic and a polymer binder disposed within the ceramic. The ceramic includes sulfide-containing electrolyte and the polymer binder has a molecular weight of from 50 to 2000 kg/mol. A method of manufacturing a solid-state electrolyte membrane is further provided.

### CROSS-REFERENCE TO RELATED APPLICATIONS

This application claims the benefit of U.S. Provisional Application 63/559,425, filed Feb. 29, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to the field of solid-state batteries, and more specifically to free-standing sulfide solid-state electrolyte films/membranes and other applications.

### BACKGROUND OF THE INVENTION

Flexible, thin-film sulfide solid-state electrolytes (SSEs) are crucial in the development of next-generation, high-energy-density solid-state batteries (SSBs), offering enhanced stability and performance. Sulfide SSEs are particularly notable for their high ionic conductivity and cost-effective, earth-abundant composition, distinguishing sulfide SSEs among other solid electrolyte materials. The chemical stability and ionic conductivity of sulfide SSEs, demonstrated especially by compounds like Li₃PS₄, are further enhanced through halide substitutions, leading to improved electrolytes such as argyrodite (Li₆PS₅X, where X is Cl, Br, or I)). Despite the advancements in sulfide-based solid electrolytes used in thin and flexible films, challenges still remain.

Utilizing wet chemistry, particularly the addition of a solvent and a polymeric binder, is a promising approach to overcome challenges in producing thin, flexible sulfide solid-state electrolytes, enhancing scalability and mechanical stability. Selection of binders, solvents, and selection of slurry processing have been investigated to fabricate sulfide sheet-type SSEs. Generally, in sheet-type sulfide electrolytes, polymer binders provide structural and mechanical stability, which are the result of adhesive forces provided by polar moieties, such as nitrile groups, or by entanglement in the absence of such moieties. Polymer entanglement effects arise at sufficiently high molecular weight (or chain lengths) and concentration. Additionally, binder molecular weight directly impacts wet slurry viscosity and dry thin film strength through a combination of mechanical and chemical, cross- and self-interaction phenomena. The nature of these interactions can have a dramatic effect on both the processability and performance of SSE thin separators.

### SUMMARY OF THE INVENTION

A solid-state electrolyte membrane is provided. The solid-state electrolyte membrane includes a ceramic and a polymer binder disposed within the ceramic. The ceramic includes a sulfide-containing electrolyte. The polymer binder has a molecular weight of from 50 to 2000 kg/mol.

A solid-state battery cell is also provided. The solid-state battery cell includes a casing, and a cathode and anode disposed within the casing. The solid-state battery cell further includes a current collector. The solid-state battery cell also includes a solid electrolyte membrane separating the cathode from the anode. The solid-state electrolyte includes a ceramic, and a polymer binder disposed within the ceramic. The polymer binder has a molecular weight of from 50 to 2000 kg/mol.

A method of manufacturing a solid-state electrolyte membrane is further provided. The method includes the step of dissolving a polymer binder in a solvent to yield a binder solution. The binder solution and a sulfide-containing electrolyte are combined to give a binder-electrolyte slurry, and the binder-electrolyte slurry is cast on a substrate. The binder-electrolyte slurry is dried to yield a solid-state electrolyte membrane. The polymer binder has a molecular weight of 50 to 2000 kg/mol.

These and other features of the invention will be more fully understood and appreciated by reference to the description of the embodiments and the drawings.

### BRIEF DESCRIPTION OF THE DRAWING

FIG. 1 is a schematic depicting a solid-state battery cell including the solid-state electrolyte.

FIG. 2A is a collection of images of films cast with varying binder mass loadings and molecular weights.

FIG. 2B is a graphical depiction of Mandrel bending test results, plotted against molecular weight (kg/mol) and binder loading (wt. %).

FIG. 2C is a schematic illustration of polymer solution concentration regimes.

FIG. 3A is a series of representative micrographs of etched 5 wt. % 85, 400, 850, and 1270 PIB samples.

FIG. 3B is a series of SEM (top), EDX elements maps (middle), and EDX carbon maps (bottom) of 5 wt. % 400, 850, and 1270PIB-LPSCl film surface.

FIG. 4 is a plot of porosity (surface defects) of 5 wt. % PIB-LPSCl films, as analyzed from SEM (500×, 1 k×, and 2 k× micrographs).

FIG. 5 is a plot of estimated pore volume, based on the evaluated porosity (surface defects).

FIG. 6A is a series of cross-sectional SEM micrographs of various LPSCl films and their corresponding EDX mapping. The scale bar is 50 μm.

FIG. 6B is a bar graph plotting film thickness for the several examples.

FIG. 7 is a set of cross-sectional SEM micrographs of the 1270 PIB on NMC811 composite cathodes after cold pressing.

FIG. 8A is a graph plotting grain boundary resistance for various binder weight loadings.

FIGS. 8B-C are graphs potting grain boundary resistance for various molecular weights at set binder weight loadings (i.e., 5 wt. % and 7 wt. %).

FIG. 8D plots critical current density for increasing molecular weight.

FIG. 9 is a bar graph plotting bulk resistance and charge transfer resistance of 5 wt. % PIB-LPSCl films for various binder molecular weights.

FIG. 10A-C are a set of nanoidentation stress-strain curves for 400PIB, 850PIB, and 1270PIB composites.

FIG. 11A is a plot showing the stripping-plating evaluation of the Li|LPSCl|Li symmetric cells.

FIG. 11B is a plot showing the zoomed view of the voltage profile.

FIG. 12A is a plot of full cells fabricated using 5 wt. % 400PIB-LPSCl separators showing specific discharge capacity fading.

FIG. 12B-D are plots of cycling profiles for 400PIB-LPSCl, 850PIB-LPSCl, and 1270LPSCl for cycles 1, 2, 5, 10, 20, and 50.

FIGS. 12E-G are plots of differential capacity analysis for 400PIB-LPSC1, 850PIB-LPSCl, and 1270LPSCl for cycles 1, 2, 5, 10, 20, and 50.

FIG. 13A is a set of galvanostatic cycling profiles for 400PIB-LPSCl, 850PIB-LPSCl, and 1270LPSCl up to 100 cycles.

FIG. 13B is an overall cell cycling profile during the first 100 cycles for all samples.

FIGS. 14A-C are plots depicting rate performance for different PIB-LPSCl cells (i.e., 400PIB-LPSCl, 850PIB-LPSCl, and 1270LPSCl).

FIGS. 15A-B are TXM images of NMC for a charged sample and a charged-discharged sample.

FIG. 16 is a schematic illustration of an interfacial difference between NMC|Low-MW PIB-LPSCl and NMC|High-MW PIB-LPSCl before/after SSB cycling.

FIG. 17A is a Nyquist plot of 5 wt. % PIB-LPSCl cells of various molecular weights as assembled.

FIG. 17B is a Nyquist plot of 5 wt. % PIB-LPSCl cells of various molecular weights after 20 cycles.

FIG. 17C is a Nyquist plot of 5 wt. % PIB-LPSCl cells of various molecular weights after 50 cycles.

FIG. 18A is a cross-sectional Raman map of the cathode/400PIB-LPSCl interface.

FIG. 18B is plot of norm. intensity against Raman shift for the 400PIB-LPSCl Example.

FIG. 18C is a cross-sectional Raman map of the cathode/1270PIB-LPSCl interface.

FIG. 18D is a plot of norm. intensity against Raman shift for the 1270PIB-LPSCl Example.

FIG. 19A is a plot of differential capacity comparison between 850 and 1270 PIB-LPSCl Examples.

FIG. 19B depicts stacked Nyquist plots of SSBs during the initial discharge process for an 850PIB-LPSCl embodiment.

FIG. 19C plots the total resistance of the bulk and charge transport across the LPSCl|NMC811 interface as a function of the state of discharge (SOD).

FIG. 19D depicts stacked Nyquist plots of SSBs during the initial discharge process for a 1270PIB-LPSCl embodiment.

FIG. 20 is a plot depicting the projected relationship between molecular weight and binder loading for hydrogenated nitrile butadiene rubber (HNBR).

### DETAILED DESCRIPTION OF THE CURRENT EMBODIMENTS

As discussed herein, the current embodiments relate to a solid-state electrolyte (SSE) membrane (or film), an associated solid-state battery (SSB) cell, and a method of manufacture. The solid-state electrolyte membrane includes a ceramic including a sulfide-containing electrolyte and a polymer binder disposed within the ceramic. The polymer binder has a molecular weight of from 50 to 2000 kg/mol.

The ceramic comprises, alternatively consists essentially of, or alternatively consists of a sulfide-containing electrolyte. The sulfide-containing electrolyte may be an argyrodite corresponding to the general formula Li₆PS₅X, where X is a halogen atom. Specifically, X may be a fluorine, chlorine, bromine, iodine, astatine, or tennessine. Generally, the sulfide-containing electrolyte comprises, alternatively is, Li₆PS₅Cl.

The solid-state electrolyte includes a polymer binder. The polymer binder facilitates mechanical stability, particle adhesion, and interfacial contact of the solid-state electrolyte with electrodes. The polymer binder may be present in the SSE in an amount of from 1 to 10 wt. %, alternatively 2 to 10 wt. %, alternatively 4 to 10 wt. %, alternatively 4 to 6 wt. %, of the electrolyte membrane, with a basis of 100 wt. %, wherein the balance is made up by other components (e.g., the ceramic). The polymer binder has a molecular weight of from 50 to 2000 kg/mol. In certain embodiments, the polymer binder has a molecular weight of from 300 to 500 kg/mol, alternatively 350 to 450 kg/mol, or alternatively 390 to 410 kg/mol. Unexpectedly, polymer binders having molecular weights in this subrange were found to offer better ionic conductivity and higher critical current density than other polymer binders. In alternative embodiments, the polymer binder has a molecular weight of from 750 to 950 kg/mol, alternatively 800 to 900 kg/mol, or alternatively 840 to 860 kg/mol. In other embodiments, the polymer binder has a molecular weight of from 1150 to 1400 kg/mol, alternatively 1200 to 1300 kg/mol, or alternatively 1260 to 1280 kg/mol. Unexpectedly, polymer binders having molecular weights in this subrange were found to provide stronger mechanical stability and are strain-hardening, improving contact with electrodes in SSB applications. Moreover, these SSEs enhanced capacity retention in SSBs over many cycles.

The polymer binder is generally a compound selected from the group consisting of polyisobutylene (PIB), styrene-butadiene rubber (SBR), poly(methyl methacrylate) (PMMA), poly(ethylene vinyl acetate) (PEVA), hydrogenated nitrile butadiene rubber (HNBR), acrylonitrile butadiene rubber (NBR), ethylene-propylene-diene monomer (EPDM), polybutadiene (PB), and combinations thereof. In exemplary embodiments, the polymer binder comprises, alternatively consists essentially of, alternatively consists of PIB. The polymer binder may comprise, alternatively consist essentially of, alternatively consist of HNBR.

The SSE membrane may comprise the polymer binder and ceramic in a dry mass ratio of 0.1 to 0.8, alternatively 0.4 to 0.6, or alternatively 0.5 to 0.6. The SSE membrane may have a thickness of 20 to 120 μm, alternatively 40 to 120 μm, alternatively 60 to 120 μm. The SSE membrane may exhibit a critical current density of greater than 130 μA/cm², alternatively greater than 280 μA/cm², or alternatively greater than 330 μA/cm². The SSE membrane may exhibit an ionic conductivity of 5×10⁻⁵ to 6×10⁻⁴ S/cm, alternatively 1×10⁻⁴ to 6×10⁻⁴ S/cm, or alternatively 3×10⁻⁴ to 6×10⁻⁴ S/cm.

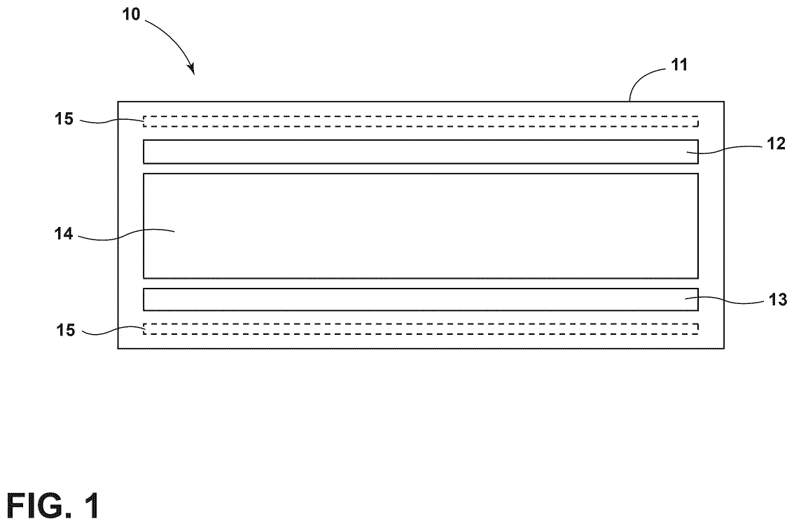

A SSB cell is also provided. The SSB cell according on one embodiment is depicted in FIG. 1 and generally designated 10. The SSB cell includes a casing 11. A cathode 12 and an anode 13 are disposed within the casing 11. The cathode 12 and the anode 13 are separated by the SSE membrane 14 described above. The SSB cell further includes a current collector 15. The SSE membrane 14 includes a ceramic comprising a sulfide-containing electrolyte and a polymer binder disposed within the ceramic and having a molecular weight of from 50 to 2000 kg/mol.

The SSB cell includes a casing 11. The casing 11 is a protective enclosure that isolates the electrodes 12, 13 and SSE membrane 14 from environmental hazards (e.g., moisture, atmosphere, and mechanical impact). The casing 11 may be configured to accommodate expansion/contraction of the internal components, establish a hermetic seal, and/or provide thermal dissipation. The casing generally comprises metal and/or polymer composites. Examples of suitable battery casing material include aluminum, stainless steel, titanium, polyether ether ketone, polyimide, and/or epoxy-based resins.

The SSB cell includes a cathode 12. The cathode may include nickel manganese cobalt oxide (NMC811) (LiNi_{0.8}Mn_{0.1}Co_{0.1}O₂); NMC622 (LiNi_{0.6}Mn_{0.2}Co_{0.2}O₂); NMC111 (LiNi_{0.3}Mn_{0.3}Co_{0.3}O₂); lithium iron phosphate (LFP) (LiFePO₄); lithium cobalt oxide (LCO) (LiCoO₂); lithium-rich manganese-based oxide (LRMO) (xLi₂MnO₃·(1−x)LiMO₂ where M=Mn, Ni, Co); lithium vanadium oxide (LVO) (LiₓV₂O₅, LiₓV₆O₁₃); or combinations thereof. In specific embodiments, the cathode is a layered oxide cathode (e.g., NMC811).

The SSB cell includes an anode 13. The anode 13 may include lithium metal; lithiated indium (LixIn); silicon/silicon-oxide; graphite (LiC₆); lithium-tin (LixSn); lithium-alloy anodes (Li—Al, Li—Bi, Li—Sn); or combinations thereof. In particular embodiments, the anode is lithiated indium. In alternative the anode is graphite.

The SSB cell includes the SSE 14 described above. As noted above the SSE 14 may include a polymer binder present in an amount of from 1 to 10 wt. %, alternatively 2 to 10 wt. %, alternatively 4 to 10 wt. %, alternatively 4 to 6 wt. %, of the electrolyte membrane, with a basis of 100 wt. %, wherein the balance is made up by other components (e.g., the ceramic). The polymer binder has a molecular weight of from 50 to 2000 kg/mol. In certain embodiments, the polymer binder has a molecular weight of from 300 to 500 kg/mol, alternatively 350 to 450 kg/mol, or alternatively 390 to 410 kg/mol. Unexpectedly, polymer binders having molecular weights in this subrange were found to offer better ionic conductivity and higher critical current density than other polymer binders. In alternative embodiments, the polymer binder has a molecular weight of from 750 to 950 kg/mol, alternatively 800 to 900 kg/mol, or alternatively 840 to 860 kg/mol. In other embodiments, the polymer binder has a molecular weight of from 1150 to 1400 kg/mol, alternatively 1200 to 1300 kg/mol, or alternatively 1260 to 1280 kg/mol. Unexpectedly, polymer binders having molecular weights in this subrange were found to provide stronger mechanical stability and strain-hardening, improving contact with electrodes. Moreover, these SSEs 14 enhance capacity retention in SSBs 10 over many cycles.

The sulfide-containing electrolyte of the SSE 14 may be an argyrodite corresponding to the general formula Li₆PS₅X, where X is a halogen atom. Specifically, X may be a fluorine, chlorine, bromine, iodine, astatine, or tennessine. Generally, the sulfide-containing electrolyte comprises, alternatively is, Li₆PS₅Cl. The polymer binder of the SSE 14 may be a compound selected from the group consisting of PIB, HNBR, and combinations thereof.

A method of manufacturing a solid-state electrolyte membrane is further provided. The method includes dissolving a polymer binder in a solvent to yield a binder solution. The binder solution and a sulfide-containing electrolyte are combined to give a binder-electrolyte slurry. The binder-electrolyte slurry is cast on a substrate. The binder-electrolyte slurry is dried to yield a solid-state electrolyte membrane. The polymer binder has a molecular weight of from 50 to 2000 kg/mol, alternatively 300 to 500 kg/mol, or alternatively 1200 to 1400 kg/mol. The solvent may comprise toluene.

The method may further comprise drying the polymer binder. The drying step may occur under vacuum at a drying temperature. The drying temperature is from 30 to 120° C., alternatively 60 to 100° C., or alternatively 70 to 90° C. The substrate may be a cathode or anode. In alternative embodiments, the binder-electrolyte slurry is cast on a temporary substrate (e.g., silicone-coated polyethylene terephthalate, mylar sheets, glass).

### EXAMPLES

### General Procedure: Sample Preparation

Poly(isobutylene) (PIB; 85, 400, 850, and 1,270 kg/mol; Scientific Polymer Products Inc., New York, U.S.) was dried at 80° C. under vacuum overnight and dissolved in anhydrous toluene (dried using 4 Å molecular sieves for a minimum of two weeks). Li₆PS₅Cl (3-5 μm; NEI Corp., New Jersey, U.S.) was used as received. PIB was dissolved in toluene (7.4 wt. % PIB), and subsequently LPSCl was added to make between 1.5 and 9.5 wt. % PIB content mixtures with a dry mass ratio of 0.54. The resulting slurries were mixed and cast.

Water-etched PIB-LPSCl samples were obtained by suspending PIB-LPSCl films in deionized water by use of double-sided carbon tape. Water selectively dissolved the LPSCl, leaving behind a water-insoluble binder. The resulting-majority-PIB samples were removed from the bath after one hour and subsequently dried under vacuum overnight to remove residual water. The resulting composite samples were then tested according to the various methodologies described further herein.

Cathode preparation: dry cathode composite was made by milling LiNi_{0.8}Mn_{0.1}Co_{0.1}O₂ (NMC), LPSCl, and vapor-grown carbon fibers (VGCF) in a turbula mixer with ZrO₂ milling media (5:1 mass ratio media: dry material) for one hour at approximately 100 rpm. 7.4 wt. % 850 kg/mol PIB in toluene was added with the dry cathode composite mixture and milled in a turbula mixer for one hour at the same speed and milling media mass ratio. The resulting slurry was cast onto carbon-coated aluminum (C@Al) substrate using a doctor blade with a 0.008-inch gap. The final composition of the composite cathode was 60:35:3:2 (NMC:LPSCl:VGCF:PIB) by mass. The active material loading was approximately 4.2 mg/cm².

### Mandrel Bending Tests

Mandrel bending tests were conducted on the exemplary PIB-LPSCl films. Free-standing films (≥5 cm in at least one dimension) were bent around 3D printed mandrels (Elegoo Mars 2; standard photopolymer resin) ranging from 2 to 32 mm in diameter.

### Morphology Evaluation Methodology

Morphology of the PIB-LPSCl samples were evaluated using scanning electron microscopy (SEM) (Zeiss MERLIN Field Emission SEM) equipped with an In-lens detector. For pristine PIB-LPSCl samples, an accelerating voltage of 5 kB was used. For water-etched PIB-LPSCl samples, an accelerating voltage of 1.5 kV was used. ImageJ and MATLAB's Image Processing Toolbox were used to process micrographs. To visualize the morphological change of LiNi_{0.8}Mn_{0.1}Co_{0.1}O₂ (NMC) cathodes at different cycling conditions, transmission X-ray microscopy (TXM) was performed at beamline 6-2 at the Stanford Synchroton Radiation Lightsource (SSRL). The sample was sealed in polycarbonate films to prevent conversion with atmosphere. The charged sample was cycled once and discharged once at C/10 and held for 1 hour. The samples were pre-prepared in an argon filled glovebox with O₂ and H₂O level less than 0.1 ppm. TXM images were taken at 8340 eV, above the Ni K-edge. The obtained images were processed using TXM Wizard software for reference correction and image alignment.

### Ionic Conductivity Methodology

Ionic conductivity measurements were performed in R2032-type coin cells. Samples were cold pressed with carbon-coated aluminum (C@Al) current collectors in a ½″ stainless steel split die at 600 MPa for 5 min. The C@ Al|PIB-LPSCl|C@Al symmetric cells were ejected from the die and hermetically sealed in a coin cell with a 500-μm-thick stainless-steel spacer and spring. Potentiostatic electrochemical impedance spectroscopy (EIS) was conducted using a VMP3 potentiostate (Biologic). Measurements were preformed between 1 MHz and 100 mHz with an excitation amplitude of 10 mV.

Li stripping and plating tests were performed in PEEK cells under argon at room temperature. Cells were cold pressed at 600 MPa for 5 minutes with Li-coated copper electrodes (Li@Cu; 40 μm Li layer; MSE) and cycled under approximately 1 MPa. To assess critical current density, the Li@Cu|PIB-LPSCl|Li@Cu symmetric cells were cycled for one charge/discharge cycle (30 minutes each charge and discharge) starting at 100 μA/cm² and increasing by 50 μA/cm² until the maximum value of 350 μA/cm² was achieved.

Full cell testing was performed in PEEK cells at room temperature in an argon-filled glovebox. Three 6 mm 5 wt. % PIB-LPSCl discs were centered in a 6 mm PEEK cell, and 360 MPa was applied for 1 minute. One 6 mm cathode was centered in the cell, and 900 MPa was applied to the cell for 3 minutes. Finally, one 5 mm indium foil disc (150×150TF, Custom Thermoelectric) and one 6 mm Cu foil disc were added. The assembled Cu|Li|SSE|cathode full cells were cycled at C-rate of C/5 between 2.0 and 3.7 V vs. Li/In for 60 cycles under a stack pressure of approximately 50 MPa. EIS was performed prior to cycling and after every 10^{th} cycle.

### Mechanical Testing Methodology

In order to obtain mechanical characteristics of the films the nanoidentation with a spherical tip was performed. The loading with a spherical tip has two main advantages compared to using pyramidal indenter: i) range of stresses can be applied within one experiment and stress-strain curves can be obtained from nanoidentation data, ii) larger volume of material is probed which is advantageous when studying effective response of the composites. A diamond spherical tip with 50 μm diameter was used. The nanoindentation was performed in continuous stiffness measurement (CSM) mode which facilitates determination of the elastic part of the displacement into surface as

$${h}_{e} = \frac{3}{2} P \frac{dh}{dP}$$

where dP/dh is the CSM stiffness corrected for the frame stiffness measured during calibration. The contact radius is then calculated from the contact depth h_{c} and the radius of the spherical indenter Rᵢ as

a_{c}=\sqrt{2Rᵢh_{c}}

and following the contact depth is defined as h_{c}=hₜ−0.5hₑ with hₜ being the total depth of indentation. The indentation strain is defined as εᵢ=a_{c}/Rᵢ and indentation stress as σₜ=P/(πa_{c}²). Stress and strain as defined herein are not equivalent to stress and stain obtained under uniaxial tension or compression. The dimension and material fragility of the exemplary samples dictated the use of nanoindentation techniques to assess mechanical behavior.

Nanoindentation was performed using an InForce 1000 actuator by Nanomechanics Inc. (a KLA Company) which was installed inside a Tescan Mira 3 SEM. The nanoindentation was performed under SEM vacuum However, a brief exposure (˜10 seconds) to the lab atmosphere was allowed to attach the exemplary samples to a bi-directional stage of the nanoindenter. It is believed that formation of any surface reaction products during the brief exposure to atmosphere did not influence mechanical behavior at depths of nanoindentation of several micrometers. Mounting of the exemplary samples on tubes was performed inside a glovebox and the exemplary samples were transported to a microscope inside sealed argon filled jars. Each exemplary sample was subjected to a 5×5 matric of nanoindentations with 100 μm spacing between the indents. All experiments were performed at the temperature of the laboratory (20° C.) and the thermal drift was limited to less than 0.1 nm/s. The nanoidentation was done in CSM mode with a nominal strain rate of 0.2 1/s, maximum load of 100 mN and maximum penetration depth of 6 μm.

### Results and Analysis

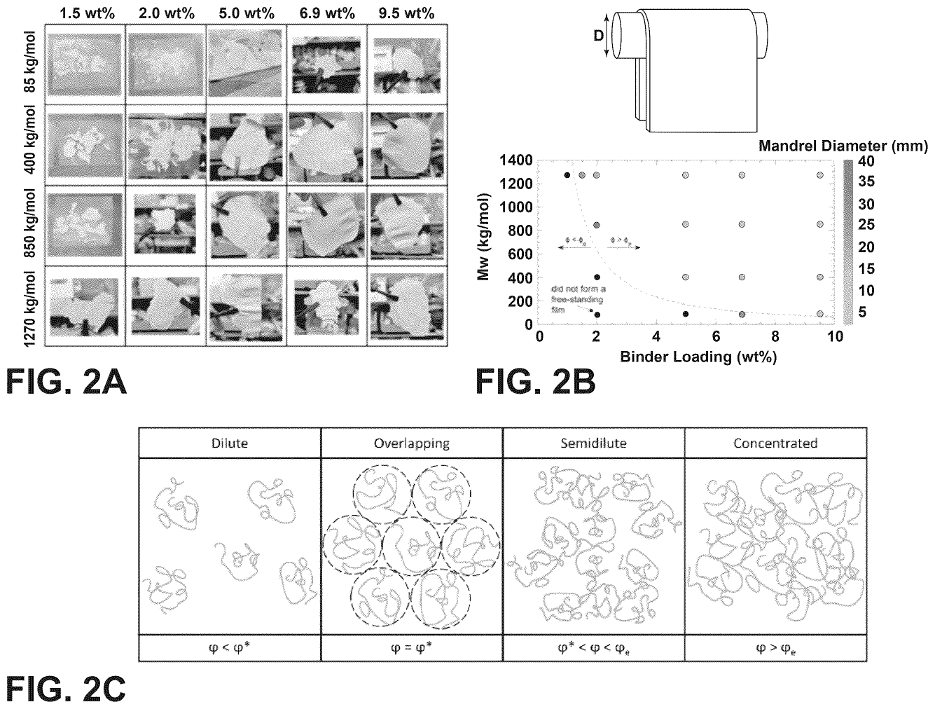

Mandrel testing was performed to measure flexural strength. As depicted in FIGS. 2A-2C, free-standing LPSCl films with high molecular weight binder and higher mass loadings of binder demonstrated increased flexural strength.

The number of segments per PIB chain (N) was calculated by the following equation:

$$N = \frac{M}{{M}_{0}}$$

where M is the polymer molecular weight and M₀ is the molecular weight of the repeating monomer unit. The number of segments per entanglement strand, Nₑ, is given by the equation:

$${N}_{e} = \frac{{M}_{e}}{{M}_{0}}$$

where Mₑ is the molecular weight of the entanglement strand. Mₑ was estimated to be a constant value of 6,700 g/mol. For purposes of the calculation, ideal chain statistics (i.e., that the interaction energy between a solvent molecule and a polymer segment is equal to the interaction energy between two polymer segments). PIB and toluene (a processing solvent) have a Flory-Huggins interaction parameter of 0.488 (close to the ideal of 0.5). The exemplary slurries have a radius of gyration R_{g}, of the polymer chain that is not perturbed by the presence of other particles. The interparticle distance (Dᵢₚ) is over 10 times greater than the polymers' R_{g} for all molecular weights used (Dᵢₚ>>R_{g}). A polymer chain will only interact with a surface if the chain is with ˜R_{g} of that surface. Toluene solvent evaporates relatively quickly as a result of its low vapor pressure, and as a consequence it is believed that polymer chains do not have adequate time to minimize free energy as the slurry dries.

The polymer chains are effectively locked into non-equilibrium positions within the film. The overlap concentration, ϕ*, is a function of N and ν, a parameter dependent on solvent quality (ν=0.5 in the ideal case), as shown in the equation below:

$${ϕ}^{*} = {N}^{- v}$$

Using the Edwards tube model, entanglements restrict the motion of any given chain to a confining tube of diameter, a. The value of “a” in the melt state is give by the equation below:

a=b\sqrt{Nₑ}

where b is the length of a chain segment, or Kuhn length. The entanglement concentration, ϕ_{c}, is the concentration at which the tube diameter is equal to the end-to-end length of the chain and is given by the equation below:

$${ϕ}_{e} = {( \frac{a}{b} )}^{3 / 2} {N}^{- 3 / 4}$$

The different concentration regimes are depicted in FIG. 2C.

FIG. 2B depicts the dimensional integrity of the LPSCl thin films dependent on the molecular weight and the mass loading of the binder. Films within the entanglement regime successfully endured bending at minimal diameter of 2 mm without damage. Conversely, films with low molecular weight PIB at reduced mass loadings either did not form a free-standing film exceeding 5 cm in any dimension or lacked the flexibility to wrap around a 32 mm mandrel without irreversible deformation. Films near the entanglement threshold exhibited limited flexibility, bending around mandrels of 6 to 32 mm diameter but not ≤5 mm.

The Examples demonstrate (i) films produced with binder molecular weights and volume fractions surpassing an entanglement threshold (ϕ>ϕ_{c}) exhibited markedly enhanced mechanical robustness compared to those below this threshold; and (ii) higher molecular weight PIB facilitated the creation of mechanically stable, free-standing films with reduced binder content.

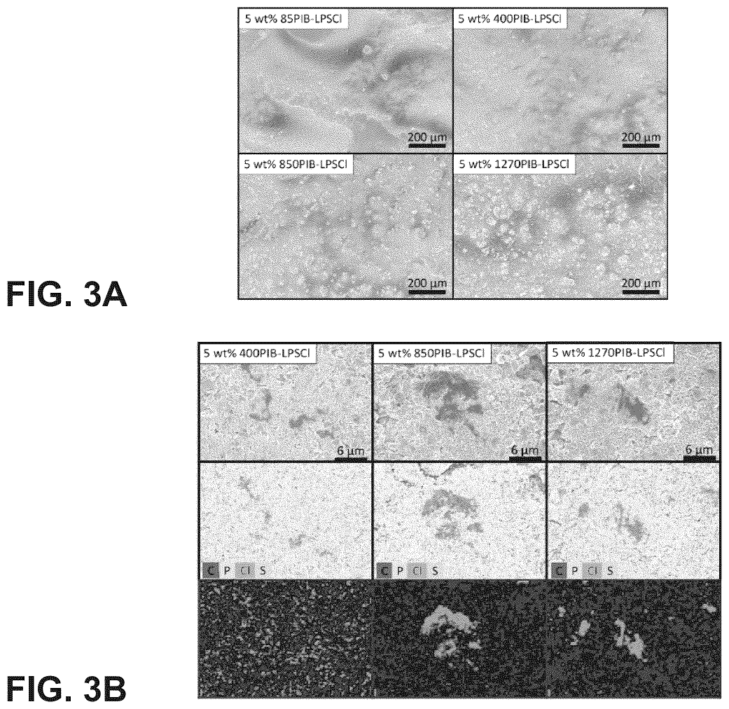

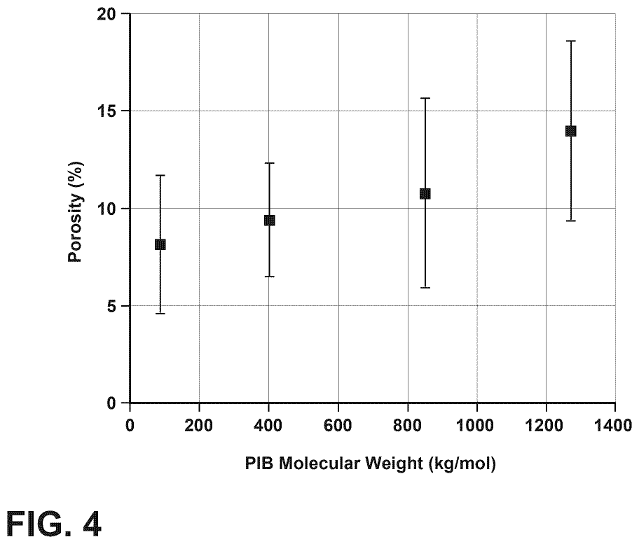

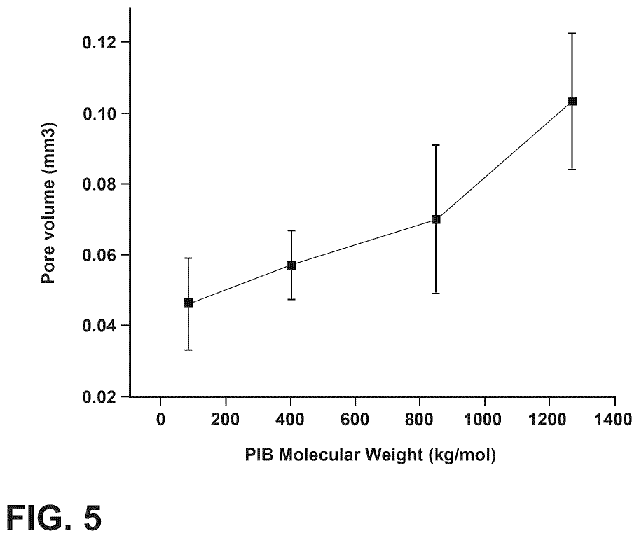

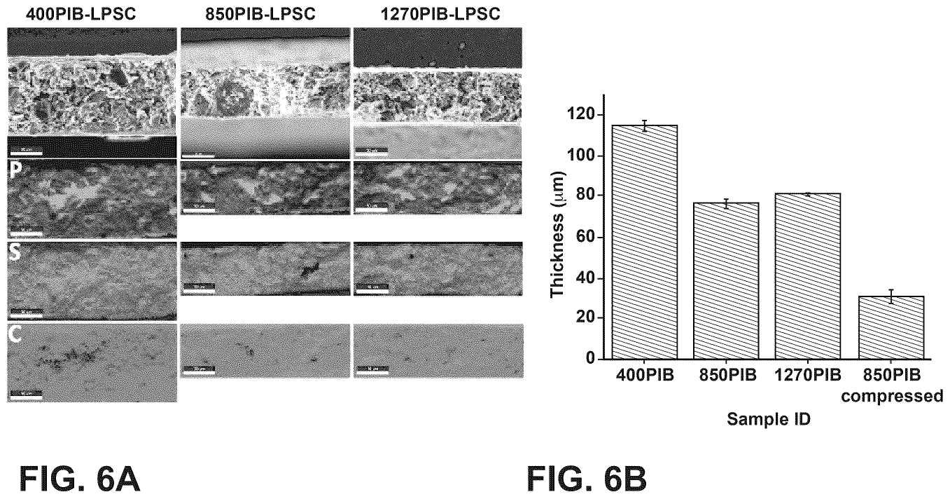

Microscopic structure of the exemplary films was assessed using scanning electron microscopy (SEM) and energy-dispersive X-ray spectroscopy (EDX), measuring the degree of dispersion of PIB with the exemplary films. Representative SEM micrographs are depicted in FIG. 3. FIG. 3A depicts water-etched PIB-LPSCl films, while FIG. 3B shows planar view of each film surface and associated carbon map. The 400PIB Example dispersed more evenly than higher molecular weight Examples, which exhibited discrete pockets with dimensions on the order of several microns. Defect density (or porosity) is shown as a function of binder molecular weight in FIG. 4 and estimate pore volume is provided in FIG. 5. The surface concentration of PIB was delineated from the total porosity (i.e., the total sum of cracks, pores, and binder-rich domains) using energy-dispersive X-ray spectroscopy (EDX) analysis. The relative surface binder was calculated by taking a ratio of carbon to sulfur (C/S), as shown in FIG. 6.

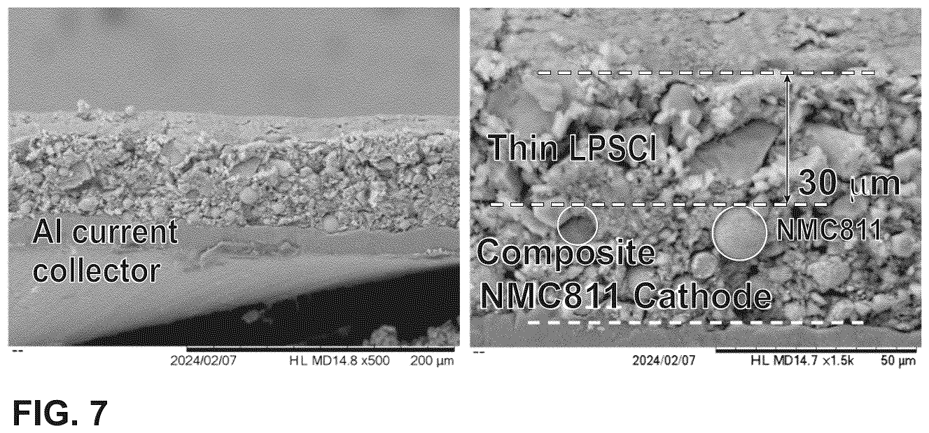

SEM of etched PIB-LPSCl films were performed (see FIG. 3B). As was expected in view of polymer entanglement theory, 85 PIB Example did not form a continuous network within separators. In the 85 PIB Example, rough, isolated regions of polymer binder formed, indicating localized regions exist within the 5 wt. % 85 PIB-LPSCl films wherein binder entanglement occurs. In Examples with higher molecular weight PIB-LPSCl films porosity of the binder network unexpectedly increases. The thickness of the PIB-LPSCl film electrolytes varies between 81 and 114 μm with the 400PIB Example having the maximum thickness (see FIG. 6B). It is believed this change in thickness results from different rheological behavior of the binder-electrolyte slurry upon film tape casting. Film thickness was reduced up to 63% after cold pressing (see FIG. 7). The cold pressed films are believed to have a smaller pore volume.

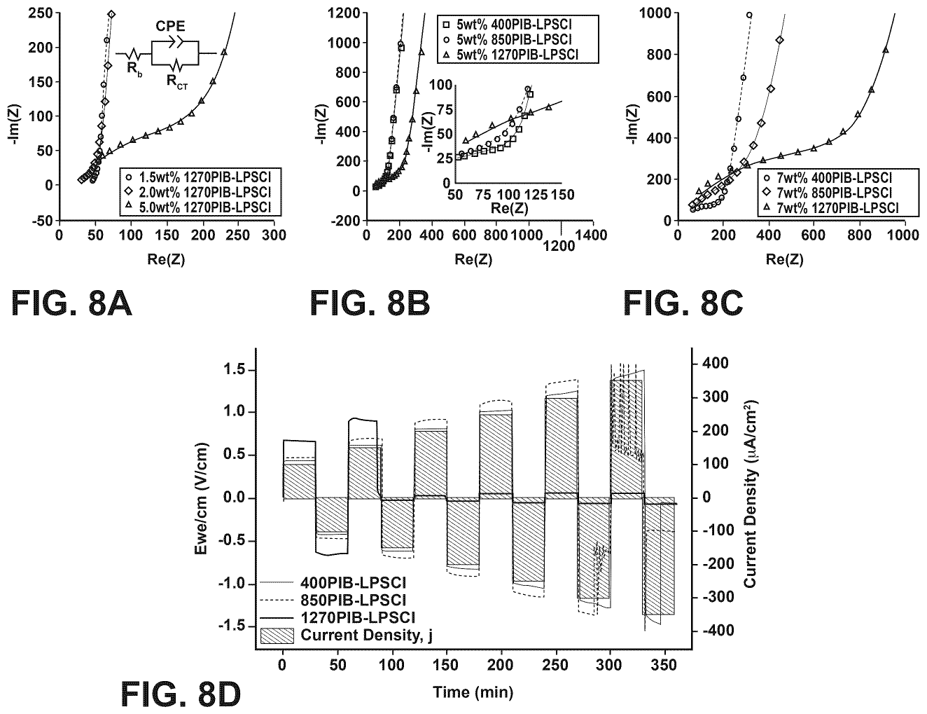

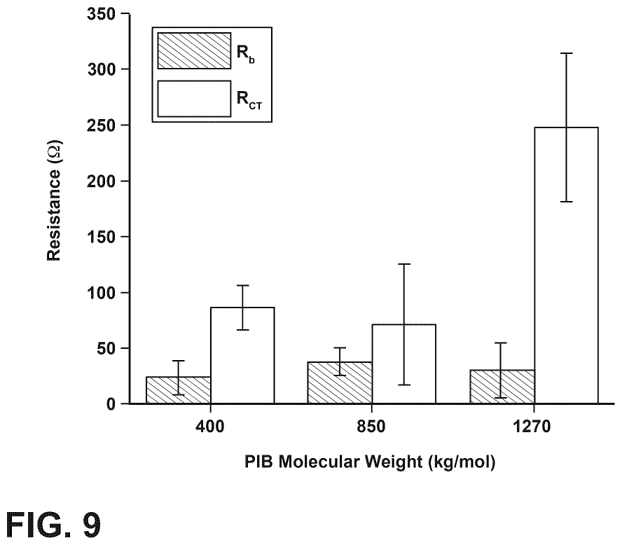

Viability of the exemplary PIB-LPSCl films for use in electrochemical cells was evaluated using electrochemical impedance spectroscopy (EIS) and crucial current density (CCD) testing. Results of EIS and CCD testing are shown in FIG. 8. As 1270PIB binder loading increased, grain boundary resistance increased (depicted by the semicircle diameter in FIG. 8A). At 5 and 7 wt. % loadings, grain boundary resistance was also found to increase with increasing PIB molecular weight, with 1270PIB exhibiting a marked increase over both 400PIB and 850PIB (see FIGS. 8B-C). The increased impedance in the low-frequency region was attributed to increased grain boundary resistance due to the identical sample chemistries and mass compositions. The bulk resistances of the exemplary films did not deviate significantly from one another (see FIG. 9). The calculated ionic conductivity values of each exemplary film are listed in Table 1.

TABLE 1
Conductivity of PIB-LPSCl films

| M_{W} | Sigma_{R1} | | Sigma_{R1+R2} | |
|---|---|---|---|---|
| (kg/mol) | Avg (S/cm) | St. Dev. (S/cm) | Avg (S/cm) | St. Dev. (S/cm) |
| 400 | 5.08 × 10⁻⁴ | 8.88 × 10⁻⁵ | 3.38 × 10⁻⁴ | 2.89 × 10⁻⁵ |
| 850 | 2.13 × 10⁻⁴ | 8.52 × 10⁻⁵ | 6.21 × 10⁻⁵ | 5.54 × 10⁻⁵ |
| 1270 | 8.15 × 10⁻⁵ | 4.36 × 10⁻⁵ | 5.60 × 10⁻⁵ | 1.55 × 10⁻⁵ |

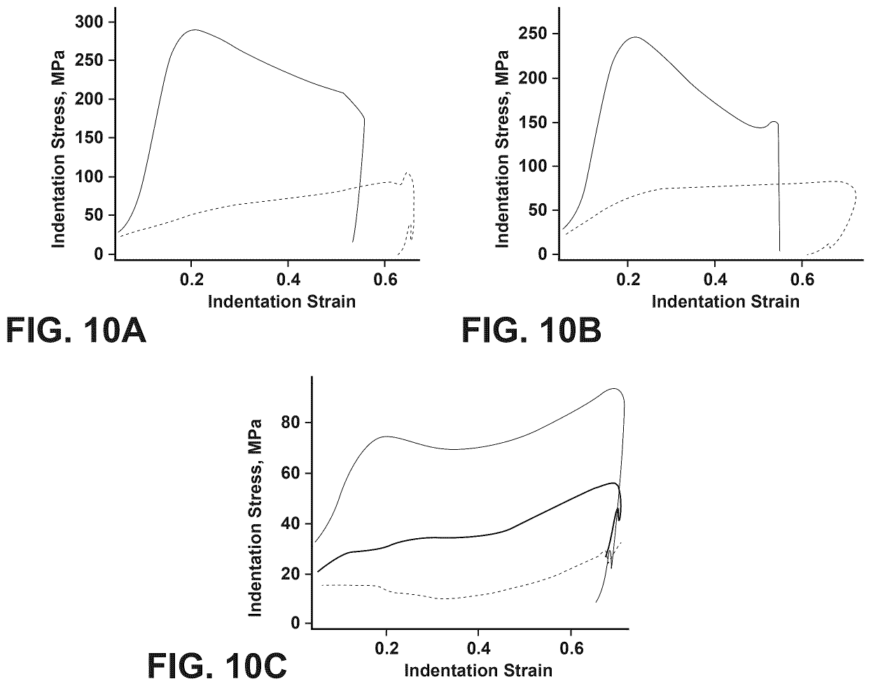

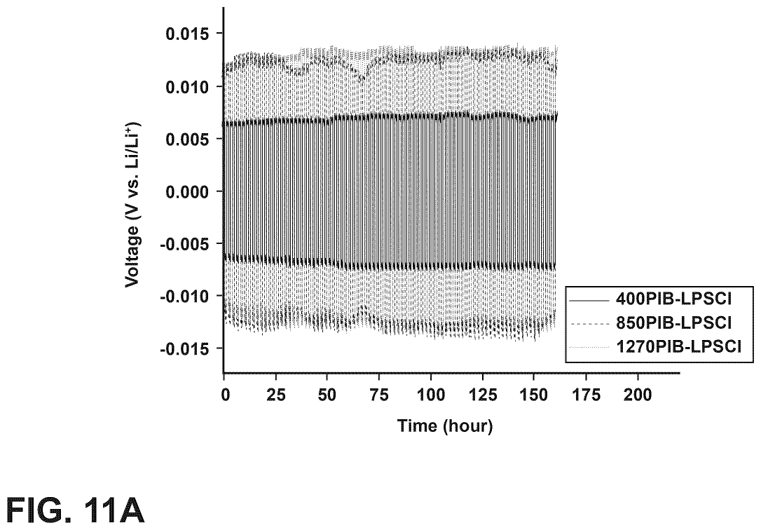

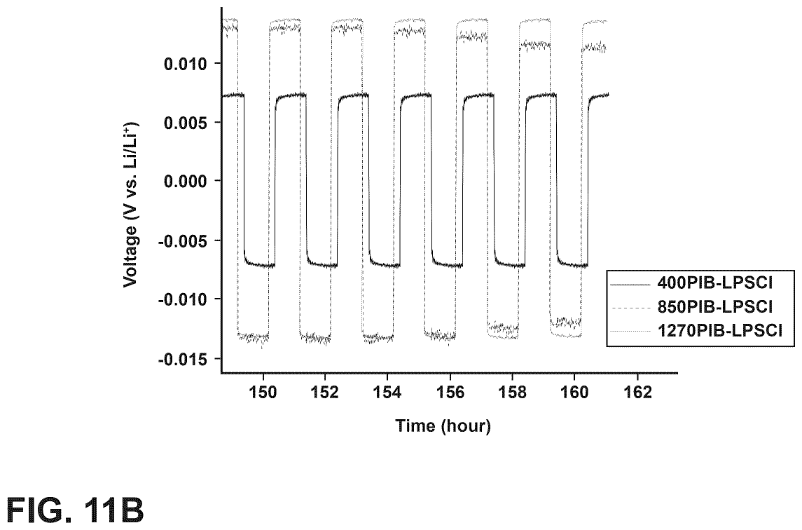

Unexpectedly, the CCD of Li|PIB-LPSCl|Li cells varied inversely with PIB molecular weight (see FIG. 8D). The exemplary films 400PIB-LPSCl, 850PIB-LPSCl, and 1270 LPSCl films failed at current densities of 350, 300, and 150 μA/cm², respectively. The variation in current density failure is correlated with film surface heterogeneity, as observed in EDX (see FIGS. 8B and 10). When a potential was applied the presence of defects promoted uneven distribution of the Li⁺ diffusion coefficient at the Li/separator interface. Heterogenous Li stripping and plating occurred, facilitating dendrite growth. Symmetric cell striping-plating evaluation at 100 μA/cm² (below the critical current density) as shown in FIG. 11. Overall, 400PIB LPSCl exhibited lower overpotenial among all exemplary films, corresponding with its overall lowest total resistance (see FIG. 9) and more homogenous binder distribution.

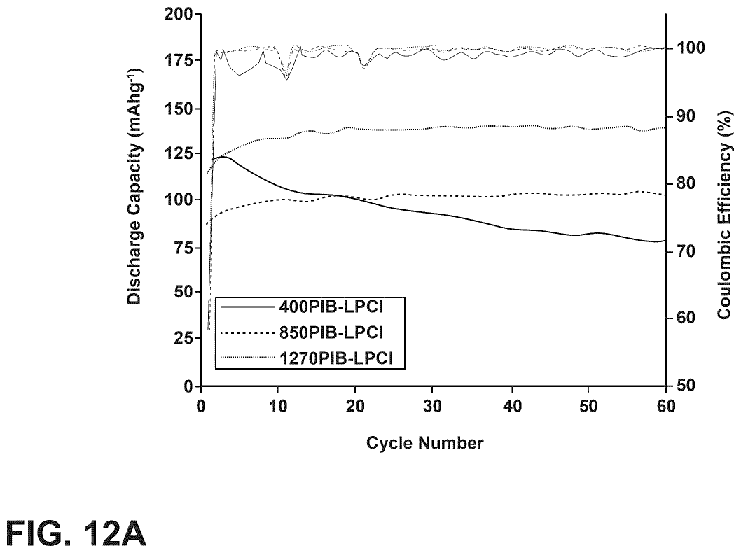

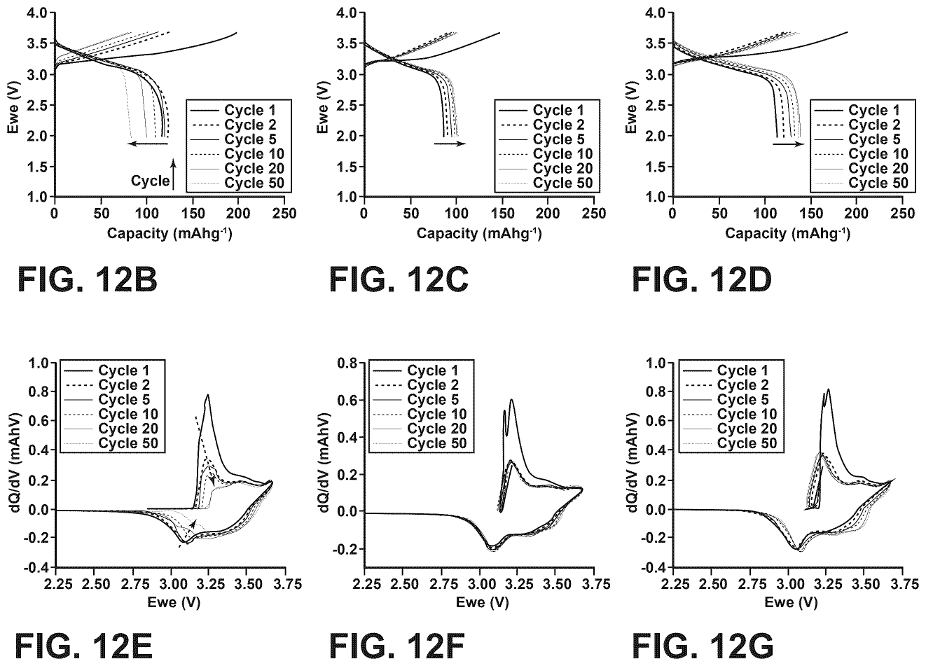

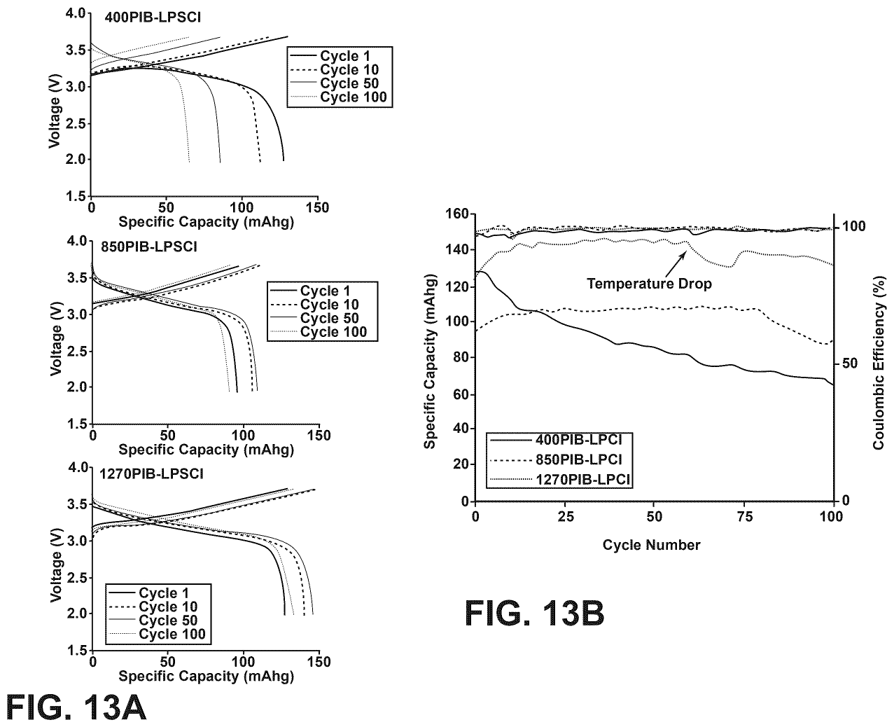

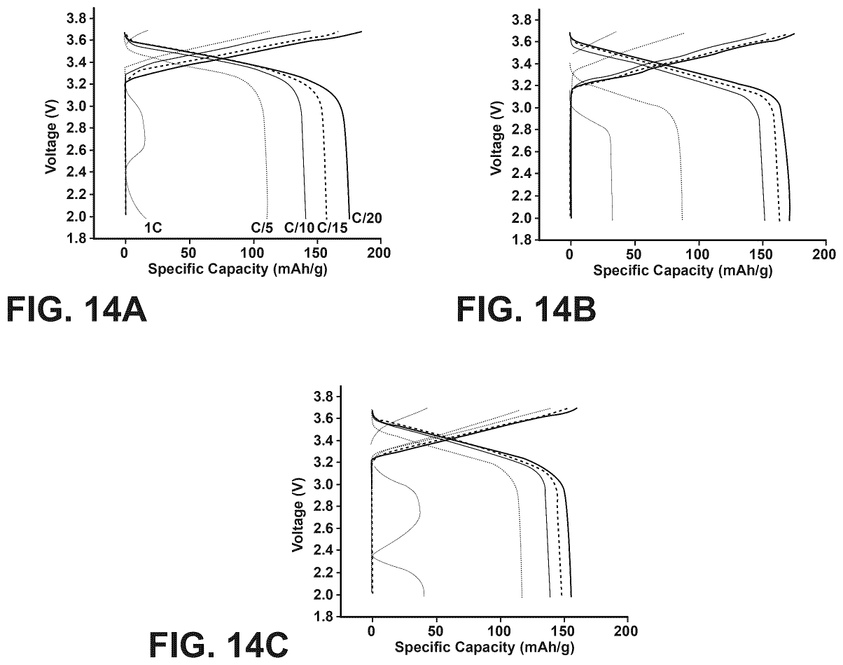

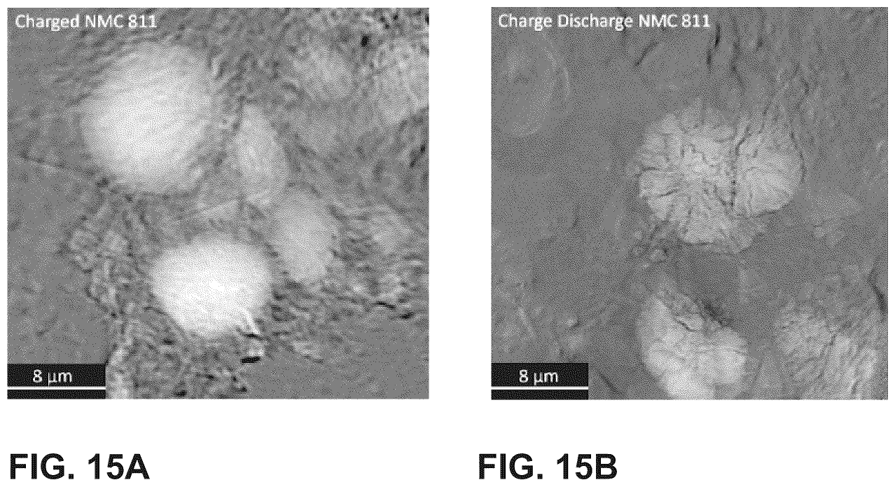

To further explore binder molecular weight effects on full cell SSB performance, SSBs were assembled that comprises LiₓIn|LPSCl|NMC811 with various exemplary LPSCl films. The binder molecular weight had a substantial effect on full cell capacity retention (see FIG. 12A and see FIG. 13 for extended cell cycling performance and FIG. 14 for rate performance evaluations). Specifically, the 400PIB-LPSCl cell showed significant capacity fade (70% initial discharge capacity) over 50 cycles. The 850 and 1270PIB-LPSCl cells, on the other hand, showed a gain in discharge capacity (120% and 121% initial discharge capacity) over the same number of cycles. Apart from side reactions in solid-state cells, capacity fade is known to occur because of NMC particle cracking and subsequent contact loss (see FIG. 15). The difference in capacity retention is believed to originate from differences in the capability among the different molecular weight exemplary films.

Results of the nanoindentation measurements are shown in FIG. 10. The stress-strain curves are shown with standard corresponding error bars. Data from shallow depth indentation was excluded to eliminate any influence of reacted surface layer material during sample transition into the SEM chamber. The data represent the portion of the experiment where the nominal rate (dP/dt)/P has reached a sable value of 0.2 l/s. This data selection allows for comparison of mechanical response among different exemplary samples. Each of the Examples showed regions with higher lower stresses, corresponding to the areas of different concentration of LPSCl in the binder matrix. Unexpectedly, the highest stress was observed in the Example with the lowest molecular weight of PIB. This high stress reflects the complex interaction between binder and the dynamics of solid particles clustering. The Example with highest molecular weight of PIB had three distinct regions, each with a characteristic stress-strain response related to the regions having different types and degrees of particle agglomeration. The highest resistance to the nanoindenter penetration was observed in the Example with the lowest molecular weight of PIB, 400 kg/mol. The Examples demonstrate substantial differentiation in mechanical behavior relative to molecular weight of PIB, as shown in FIG. 10. The lower molecular weight Examples show either a flat plateau or softening, while the 1270 kg/mol Examples show strain hardening in all three regions with different stress levels, see FIG. 10. Generally, the local nanoindentation stress-strain state is not equivalent to the bulk stress-strain curves obtained by uniform tension. However, the local stress-strain state may be representative of non-uniform lithium plating, which produces domains of a size comparable to that of the nanoindenter tip (i.e., 25 μm). Larger stresses in the 400 kg/mol Example indicate higher resistance to formation of lithium domains which may explain its higher CCD relative to the higher molecular weight examples.

The 1270PIB-LPSCl Example exhibited strain-hardening behavior (see FIG. 10C) whereas the other Examples did not exhibit strain-hardening behavior. During lithiation and delithiation as NMC particles expand and contract, the NMC particles can induce cracks and fractures within the electrode, resulting in potential contact loss between NMC and LPSCl. The strain-hardening property allows for improved ability to accommodate larger deformations and maintain better contact between NMC and LPSCl and reduce the likelihood of crack propagation and detachment. The binder's ability to maintain NMC/LPSCl interfacial integrity ensures more consistent access to the active material for lithium ions, thereby sustaining the cell's capacity and prolonging its life.

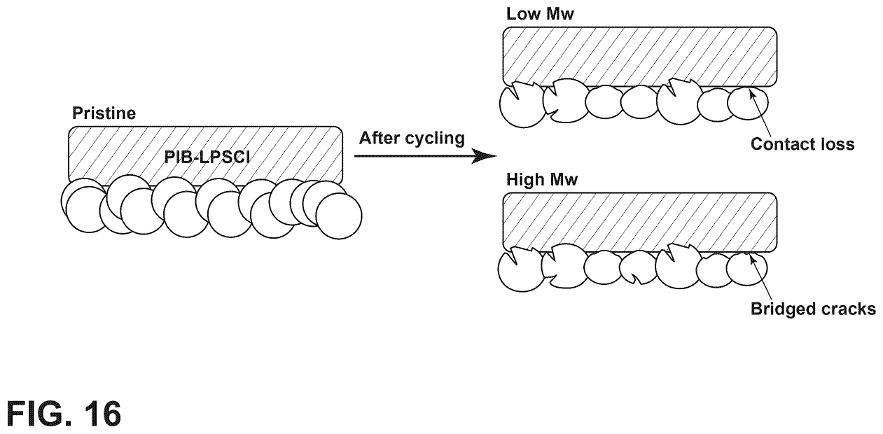

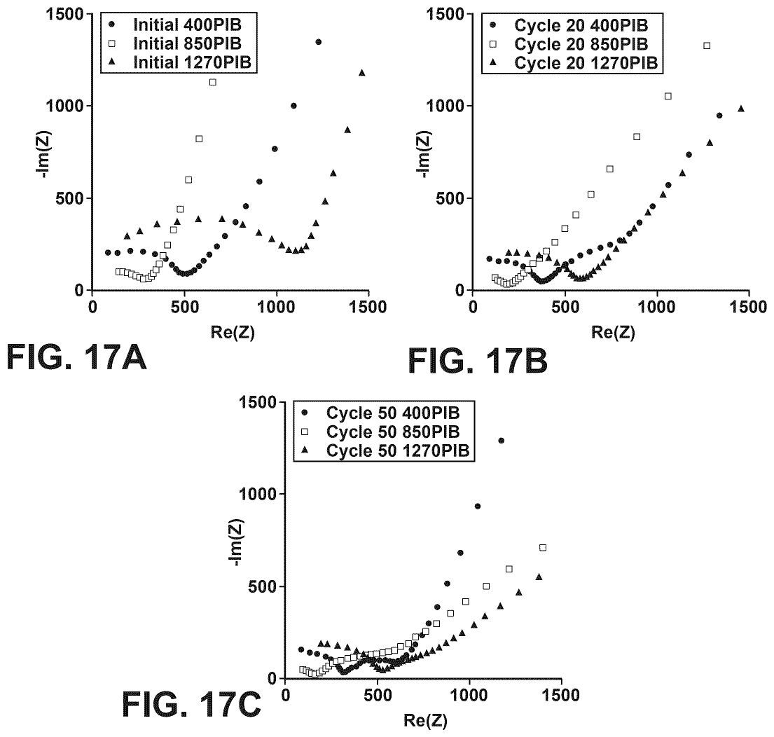

The difference in durability is depicted schematically in FIG. 16. Upon intensive galvanostatic cycling, continuous lithiation and delithiation of the NMC particles result in inevitable volumetric changes and cracks. Such cracks in the PIB-LPSCl with low molecular weight binder may exceed its yield strength, leading to contact loss between the NMC particles and the LPSCl solid electrolyte. Whereas the PIB-LPSCl with high molecular weight binder exhibits strain hardening and possesses a higher yield point, thereby capable of accommodating larger deformations at the NMC|LPSCl interface. As shown in FIGS. 12E-G, on both the anodic and cathodic branches of FIG. 12E, dQ/dV peak intensity declines and peak position shifts to increasingly larger overpotentials. Intensity loss indicates a loss of Li inventory, which was expected for all three Example cells between the first and second cycles due to in-situ alloying of Li with the indium foil electrode, and the peak intensity of the 400PIB-LPSCl cell exhibits severe intensity loss at subsequent cycles. Li inventory is lost when contact imishes and conduction pathways are irreversibly cut off. Shifting of the peak centered at 3.25 V, for example, from lower to higher potentials indicates more energy is required to achieve Ni oxidation (Ni²⁺→Ni³⁺) and concomitant phase transition from a monoclinic structure to a hexagonal structure. More energy is required to incite phase transformation due to a decreased number of conduction pathways. Comparing the Nyquist plots of the full cells in their pristine state (FIG. 17A) and after 20 cycles (FIG. 17B), the 400PIB-LPSCl cell developed a second semicircular feature, indicative of charge transfer resistance (R_{CT}). After 50 cycles (see FIG. 17C), the second semicircular feature was even more prominent in the 400PIB-LPSCl cell, and similar features appeared in the higher molecular weight PIB cells.

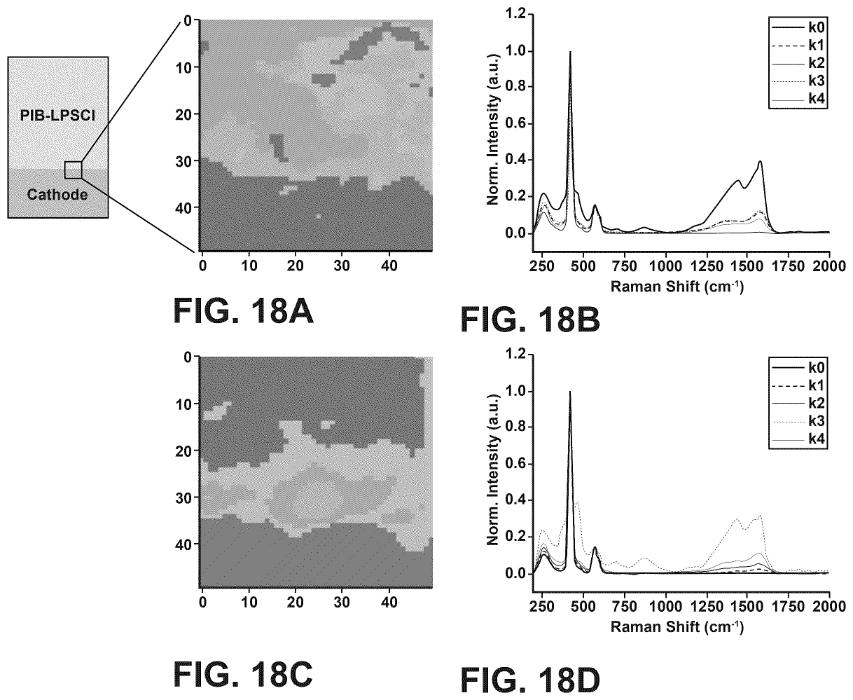

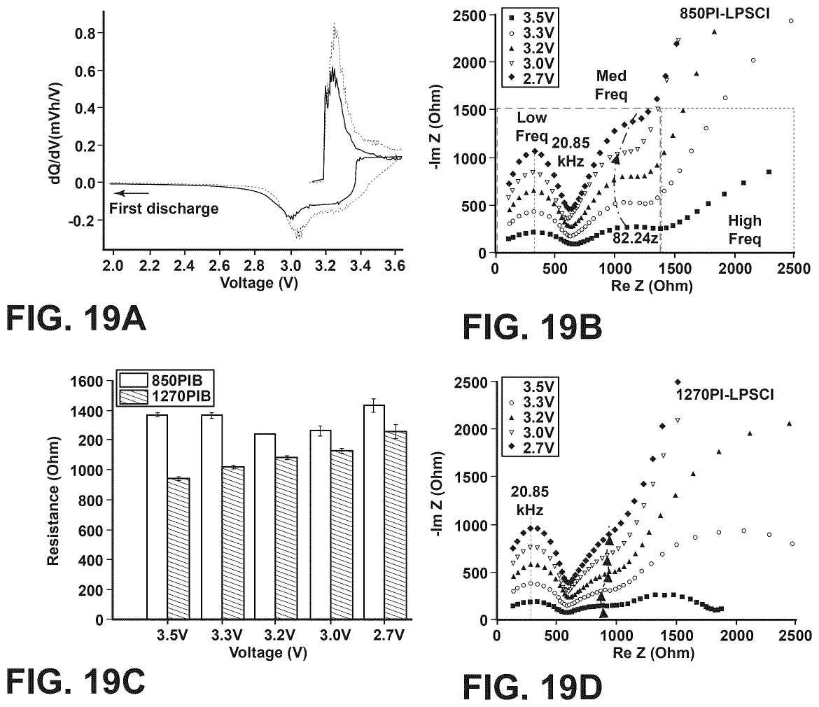

When the capacity leveled off by around cycle 20, R_{CT} of the 400, 850, and 1270PIB cells were 305Ω, 132Ω, and 157Ω, respectively. R_{CT} and bulk resistance (R_{b}) at cycles 1, 20, and 50 are given in Table 2. Cross-sectional Raman mapping was performed on cycled 400PIB and 1270PIB-LPSCl cells to assess potential chemical dissimilarities between SEIs. As depicted in FIG. 18, there is no significant difference in the chemical signature of the formed SEIs, indicating the origins of the disparate full cell performance are physical in nature. Both the 850PIB-LPSCl and 1270PIB-LPSCl samples experienced a capacity gain during the first 20 cycles, which is different from the capacity decaying trend observed for the 400PIB-LPSCl Example. Since all of the Examples exhibited a lowered bulk resistance, as evidenced in Table 2, such a phenomenon is unlikely to be determined by reduced bulk resistance during the first 20 cycles. However, the charge transport resistance for both the 850PIB-LPSCl and 1270PIB-LPSCl Examples is smaller than that of the 400PIB-LPSCl (by more than 50%). This phenomenon is believed to be partially due to the counteracting effects of reduced bulk resistance versus increased charge transport resistance. The total resistance of the 850PIB-LPSCl is higher than that of the 1270PIB-LPSCl during the initial discharge cycles (FIGS. 19A-D), contributing to a larger energy barrier for lithiation, which may be responsible for the smaller initial capacity of the 850PIB-LPSCl Example.

TABLE 2
Bulk (R_{b}) and charge transfer (R_{CT}) resistance of 5
wt. % PIB-LPSCl full cells at cycles 1, 20, and 50.

| | Molecular Weight (kg/mol) | | | | | |
|---|---|---|---|---|---|---|
| | 400 | | 850 | | 1270 | |
| Cycle | R_{b} (Ω) | R_{CT} (Ω) | R_{b} (Ω) | R_{CT} (Ω) | R_{b} (Ω) | R_{CT} (Ω) |
| 1 | 767 | 0 | 545 | 0 | 1160 | 0 |
| 20 | 397 | 305 | 185 | 132 | 457 | 157 |
| 50 | 306 | 340 | 159 | 315 | 507 | 154 |

The 850 PIB-LPSCl exhibits a notably smaller initial capacity than its 1270 PIB-LPSCl counterpart. The potential of the reduction peak during the first discharge process was 0.05 V higher for the 1270 PIB-LPSCl than for the 850 PIB-LPSCl, indicating that the energy barrier for NMC lithiation during the first cycle is lower for the 1270 PIB-LPSCl. State-of-charge (SOC) dependent EIS measurement was performed with results as shown in FIG. 7B. There were three zones in the EIS profile: a low-frequency zone (Low Freq), the medium-frequency zone (Med Freq), and the high-frequency zone (High Freq). The resistance in the Low Freq can be ascribed to bulk/grain boundary resistance (Rb), whereas the Med Freq zone is associated with NMC811|PIB-LPSCl interfacial resistance (RCT).

Rb remained stable throughout the entire discharge process. However, RCT experienced change due to the volumetric expansion of the NMC particles and the contact area change between NMC811|PIB-LPSCl solid electrolyte. Nonetheless, the total resistance (Rb+RCT) of the 850 PIB-LPSCl is larger than that of the 1270 PIB-LPSCl.

The molecular weight of the polymer binder is a pivotal factor in dictating the characteristics of sulfide SE thin film separators. As shown in the Examples, the entanglement of the binder within the argyrodite SE particle matrix is instrumental in the formation of free-standing, sheet-type separators. The Examples show that an increase in PIB molecular weight significantly reduces the minimum binder mass loading required to produce mechanically robust, free-standing films. Additionally, the Examples show that a higher molecular weight of the binder leads to enhanced grain boundary resistance and a consequent reduction in critical current density. Moreover, the Examples demonstrate that films with lower molecular weight PIB binder exhibit a more uniform binder distribution compared to their higher molecular weight counterparts. Whereas the high molecular weight PIB-LPSCl demonstrates strain hardening and exhibits a higher yield point, it is thereby capable of accommodating larger deformations at the NMC|LPSCl interface, akin to how the presence of compressed discrete elastomer pockets allows for volume adjustments without compromising active material contact, underscores an essential feature for efficient performance.

The Examples demonstrate that the influence of binder molecular weight is a paramount factor among various critical binders characteristics for high-performance sheet-type SE thin separators.

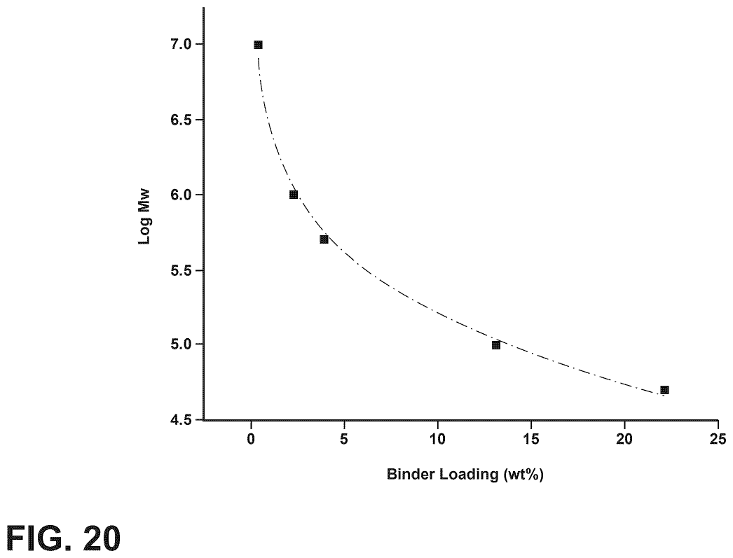

FIG. 20 depicts the projected relationship between molecular weight and binder loading for the prophetic HNBR Example. A free-standing LPSCl film solid electrolyte is formable above the dashed line.

TABLE 3
Prophetic binder molecular weight and loading for hydrogenated nitrile
butadiene rubber (HNBR) to form a quality binder-LPSCl film

| | HNBR |
|---|---|
| Monomer | C₂H₄—CH—CN |
| Mₒ (kg/mol) | 70.000 |
| M_{w} (kg/mol) | 50,000.000 |
| N | 714.286 |
| Mₑ (kg/mol | 6700.000 |
| Ne | 95.714 |
| φ* | 0.037 |
| b (nm) | 50.000 |
| a (nm) | 489.168 |
| φe | 0.221 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A solid-state electrolyte membrane comprising:
a ceramic comprising a sulfide-containing electrolyte; and
a polymer binder disposed within the ceramic having a molecular weight of from 50 to 2000 kg/mol.

2. The electrolyte membrane of claim 1, wherein the polymer binder is present in an amount of from 1 to 10 wt. % of the electrolyte membrane.

3. The electrolyte membrane of claim 1, wherein the polymer binder has a molecular weight of from 300 to 500 kg/mol.

4. The electrolyte membrane of claim 1, wherein the polymer binder has a molecular weight of from 1200 to 1400 kg/mol.

5. The electrolyte membrane of claim 1, wherein the sulfide-containing electrolyte is an argyrodite corresponding to the general formula Li₆PS₅X, and where X is a halogen atom.

6. The electrolyte membrane of claim 5, wherein the sulfide-containing electrolyte is Li₆PS₅Cl.

7. The electrolyte membrane of claim 1, wherein the polymer binder is a compound selected from the group consisting of polyisobutylene (PIB), styrene-butadiene rubber (SBR), poly(methyl methacrylate) (PMMA), poly(ethylene vinyl acetate) (PEVA), hydrogenated nitrile butadiene rubber (HNBR), acrylonitrile butadiene rubber (NBR), ethylene-propylene-diene monomer (EPDM), polybutadiene (PB), and combinations thereof.

8. The electrolyte membrane of claim 7, wherein the polymer binder comprises polyisobutylene (PIB).

9. The electrolyte membrane of claim 7, wherein the polymer binder comprises hydrogenated nitrile butadiene rubber (HNBR).

10. A solid-state battery cell comprising:
a casing;
a cathode disposed within the casing;
an anode disposed within the casing; and
a solid-state electrolyte membrane separating the cathode from the anode, the solid-state electrolyte membrane comprising:
a ceramic comprising a sulfide-containing electrolyte; and
a polymer binder disposed within the ceramic and having a molecular weight of from 50 to 2000 kg/mol.

11. The solid-state battery cell of claim 10, wherein the polymer binder is present in an amount of from 1 to 10 wt. % of the electrolyte membrane.

12. The solid-state battery cell of claim 10, wherein the polymer binder has a molecular weight of from 300 to 500 kg/mol.

13. The solid-state battery cell of claim 10, wherein the polymer binder has a molecular weight of from 1200 to 1400 kg/mol.

14. The solid-state battery cell of claim 10, wherein the polymer binder sulfide-containing electrolyte is an argyrodite corresponding to the general formula Li₆PS₅X, and where X is a halogen atom.

15. The solid-state battery cell of claim 10, wherein the polymer binder is a compound selected from the group consisting of polyisobutylene (PIB), hydrogenated nitrile butadiene rubber (HNBR), and combinations thereof.

16. The solid-state battery cell of claim 10, wherein the cathode is a layered oxide cathode.

17. A method of manufacturing a solid-state electrolyte membrane, the method comprising the steps of:
dissolving a polymer binder in a solvent to yield a binder solution;
combining the binder solution and a sulfide-containing electrolyte to give a binder-electrolyte slurry;
casting the binder-electrolyte slurry on a substrate; and
drying the binder-electrolyte slurry to yield a solid-state electrolyte membrane; and
wherein the polymer binder has a molecular weight of from 50 to 2000 kg/mol.

18. The method of claim 17, wherein the polymer binder has a molecular weight of from 300 to 500 kg/mol.

19. The method of claim 17, wherein the polymer binder has a molecular weight of from 1200 to 1400 kg/mol.

20. The method of claim 17, wherein the solvent comprises toluene.
